(19) United States
(12) Patent Application Publication
(10) Pub. No.: US 2008/0147492 A1
(43) Pub. Date: Jun. 19, 2008

(54) Modular Information System

(76) Inventor: Rudolf Benecke, Bayreuth (DE)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/597,622

(22) PCT Filed: Feb. 2, 2005
(86) PCT No.: PCT/EP2005/001028

§ 371 Date: Jan. 31, 2008

(30) Foreign Application Priority Data
Feb. 2, 2004 (DE) 20 2004 001 529.3
May 27, 2004 (DE) 20 2004 008 425.2

(51) Int. Cl. G06Q 30/00

(52) U.S. Cl. 705/14

(57) ABSTRACT

The present invention relates to a modular information system (10), in particular an advertising system, with a print medium (2, 2′) having printable sections (4, 4′) of a set of separate, substantially identical information carriers (3, 3′), wherein each information carrier comprises a larger surface as an average section of the print medium, and a bonding element (5, 5′) being arranged at at least each section (4, 4′), wherein the bonding element (5, 5′) connects a printed section (4, 4′) of the print medium and a separate information carrier (3, 3′) after the bonding in a manually releasable manner.

In a preferred exemplary embodiment of the invention, the bonding element is formed as a bonding film (3′), which comprises in at least a sub-section the form of an information communicating symbol.

### 1. TECHNICAL FIELD

The present invention relates to a modular information system, in particular to an advertising system.

### 2. PRIOR ART

In many fields of everyday life, it is necessary to provide persons systematically with information, especially with text passages or pictures. Notices on technical equipment, which provide for a warning regarding a false or dangerous application of the device are an example therefor.

While warning notices regarding dangers which are connected with a technical device are in general information desired by the user, there are also cases where an additional information is added to an object, without such information being actually desired by the person using or buying the object. The compulsory notices regarding the danger to the health, which are connected with cigarettes and which must be printed on every cigarette pack, are one example. The warning notice being tightly connected to the package, urges a buyer to notice the content of the latter, even if he merely wants to determine the cigarette label.

Without a legal constraint, it takes generally a high effort and is cost intensive to add information carriers which are not desired to an object in such a way that their content will be noticed with high probability. Especially for advertisers, who want to specifically distribute a multitude of substantially identical information carriers, for example leaflets, this represents a major technical problem. Leaflets, which are distributed or added loosely to a newspaper are predominantly not noticed but are through in the wastebasket without being looked at.

Other known methods, in which the information carrier is, e.g. by means of stapling, permanently connected to a further, desired information carrier (for example the stapled combination of hotel bill/hotel brochure) require a reliable and time-consuming handling by the service staff and are thus difficult to implement.

It is thus the technical object of the present invention to provide for a simple and cost-effective system as well as a method, by means of which information carriers may be connected to another object in such a way that the user of the object will most likely notice the content of the information carrier in a low-cost manner.

### 3. SUMMARY OF THE INVENTION

The present invention relates to a modular information system, especially an advertising system, having a print medium with printable sections, a set of separate, substantially identical information carriers wherein each information carrier comprises a larger surface as an average printable section of the print medium, and a bonding element being arranged at at least each section, wherein the bonding element connects a printable section of the print medium and a separate information carrier subsequent to the bonding in a manually releasable manner.

The inventive system connects constructive elements, which are known per se, in a new and inventive manner to an overall system, which overcomes the above problems regarding the distribution of the information carriers. The sections of the print medium may be printed with individual information required by the user one-sided or on both sides. The bonding element, which is preferably arranged on the backside of the printable section, prevents at first a separate handling of the single sections, which have to be mounted to a substrate therefor. The set of substantially identical information carriers, which is also provided in the inventive system, provides such substrates and enables in this way that each section may respectively be connected to a separate information carrier in a manually releasable manner. Since the information carrier comprises a bigger surface than the printable section, the bonding connection may be realized in a most simple way by a single movement of the hands and thus much quicker than the above-mentioned awkward stapling.

The temporary connection provided by the inventive system between the printable section and the separate information carrier has the effect that the content of the information carrier will be noticed with an unequally higher probability as in the above-described method according to the prior art (adding loose leaflets etc.).

Further, the bonding connection between the printable section and the single information carrier is formed according to the invention in such a way that the connection is manually releasable if, at a later stage, the printed section shall be stored separate from the information carrier, for example when the section is a receipt, which shall be pasted into an account book later on. In this regard, preferably the printed section may be removed from the information carrier substantially without residues.

In a preferred embodiment, the print medium with the printable sections is formed as a cash point roll for printing single receipts. Thereby, the bonding element is preferably formed as a bonding film, wherein the bonding film itself comprises at least partly the form of an information-communicating symbol.

With this further development of the invention, both aspects of information brokering on the one hand and the bonding attachment on the other hand are connected to one another by one constructive feature. In an exemplary embodiment, the bonding film therefore comprises the form of one or more characters, which may also form complete words.

In another exemplary embodiment, the bonding film of the print medium comprises periodically repeating symbols, which are arranged in such a way that at a minimum size of a section of the print medium at least one symbol is arranged on the backside of the section. In this way, it is ensured that each section may be releasably mounted onto the information carrier, for example a leaflet. The symbols, however, do not have to be identical. It is also conceivable for example a simple numbering of the sections by bonding faces being formed as respective figures on the backside of the print medium.

In one exemplary embodiment, the bonding film comprises material characteristics, in order to leave a visible imprint when sticking on a section of the print medium onto the information carrier and the subsequent removal of the section. In this manner, e.g. the internet address of an advertising company may be “printed” onto the information carrier with the bonding film, so that it may be memorized better. If symbols are concerned in this exemplary embodiment, the orientation of which is important, it is advantageous when the bonding film comprises the form of the information communicating symbol in a mirror-inverted orientation. The print is then instantaneously visible.

In a further development of the described system, respectively a printed section and an information carrier are automatically connected to one another by the bonding element. This may be realized for example by respective mechanical equipment in a cash point or a separate printer, by means of which the printed receipt is automatically stuck onto the separate information carrier.

In order to support a simple handling, the number of information carriers of one set of the modular information system corresponds preferably substantially with the number of printable sections of the print medium. Thereby, it is ensured that for every printed section substantially precisely one information carrier is provided as substrate for connection and that the overall print medium may be used in a reasonable manner. This may also be achieved by a suitable packaging of the system, e.g. a number of cash point rolls together with the corresponding number of information carriers.

According to a further aspect, the present invention relates to a method for dispensing separate information carriers, including the steps of.
Providing a print medium for printing single sections of the print medium and of a set of separate, substantially identical information carriers, wherein each information carrier comprises a bigger surface as an average section of the print medium;
Printing single sections of the print medium, wherein each section comprises one bonding element;
Applying of a respective section onto a separate information carrier, so that the connection between the section and the information carrier is manually releasable; and
Dispensing the section connected with the separate information carrier to a recipient.

Additional further developments form the subject matter of further dependent claims.

### 4. BRIEF DESCRIPTION OF THE DRAWING

In the following detailed description, a presently preferred embodiment of the invention is described by referring to the drawing. This drawing shows:

FIG. 1: a schematic illustration of a first preferred embodiment of the inventive system as well as the steps of the described method;

FIGS. 2a-e: schematic illustration of a further embodiment of the print medium according to the present invention with a bonding film in text format. FIGS. 2b/e show the transmission of the text information in the bonding film onto an information carrier.

FIG. 3: schematic illustration of an alternative embodiment in which the information communicating symbols are formed as notes.

FIG. 4: schematic illustration of a further embodiment, in which the information communicating symbol is formed as a registered trademark.

FIG. 5: schematic illustration of an embodiment, in which the print medium is printed on its backside below the transparent bonding film.

### 5. DETAILED DESCRIPTION OF A PREFERRED EXEMPLARY EMBODIMENT

In the following, a preferred exemplary embodiment of a modular information system and a method according to the present invention is described, considering as example the combination of a set of leaflets and a specifically formed cash point roll. However, it is obvious that the invention also includes systems with other print media and other information carriers.

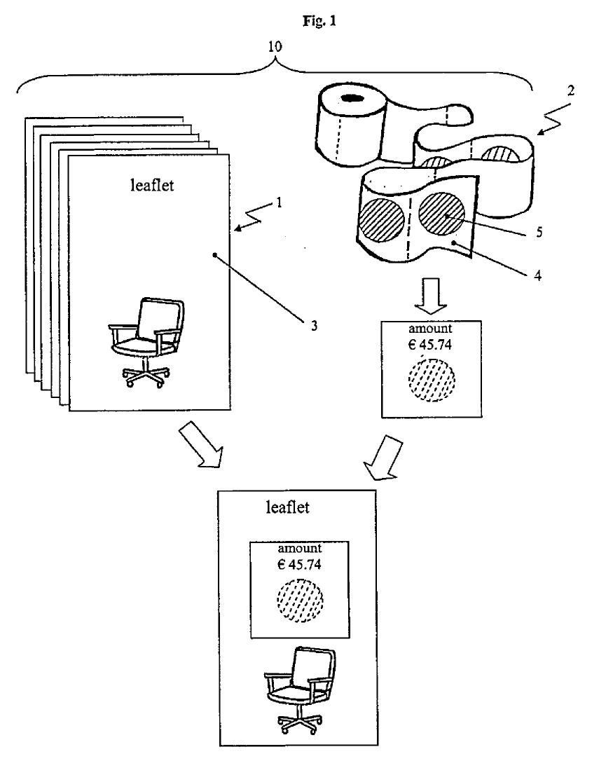

FIG. 1 schematically illustrates the general configuration: One set 1 of single separate leaflets 3, regarding e.g. a new chair, is combined with a cash point roll 2 to become a modular information system 10. The cash point roll 2 serves for printing with individual payment information of a sales point, for example of a fuel station, and therefore comprises a plurality of printable sections 4. By printing the sections 4, each is individualized so that substantially no section 4 is identical to another section. Preferably, there is no connection between the individual information printed on a section 4 and the content of the leaflet 3.

The size of the sections 4 can be defined in advance, as indicated by the dashed lines in FIG. 1 or derived from the amount of the information to be printed. On the backside, each section 4 comprises at least a subsection 5, which is provided with a bonding film 5 or the like. It is also conceivable to provide the entire backside of the cash point roll 2 with a continuous bonding film 5 or the like. However, a partly coating of the backside later facilitates the manual removal of the section 4 from the leaflet 3. Independent of the size, it is ensured by means of a suitable passivation that the bonding film 5 does not glue the cash point roll in the rolled-up condition.

However, a formation of the bonding film as an electrostatic load of at least a sub-area of each section is also possible, wherein the electrostatic load may occur before or after printing. In another embodiment, a magnetizable material is incorporated in the section, which enables an adhesion at a suitable information carrier, the further characteristics of which will be explained in detail below. Alternatively, a special coating may be applied, which is at first not adhesive and is activated only when leaving the cash point or the separate printer, for example by exposing to UV light, heating or the like. In the most simple case, also the automatic removal of a covering foil or of a carrier paper in the cash point or the printer at the dispensing of the section is possible. The activation of the special coating or the separation of the covering foil can occur also in a separate processing station, which is passed by the cash point roll after the printing. It is also possible to apply the whole bonding coating after the printing, as e.g. in the printing device itself or in another device or also manually. One advantageous realization of this supplementary coating is the contact of the backside of the printed areas of the cash point roll with a carrier paper, from which the bonding film is transferred onto the cash point roll (not shown).

After printing, the section 4 is preferably instantaneously in adhesive condition dispensed by the cash point (not shown), a separate printer (not shown) or the above-mentioned processing station. This urges the sales personnel to stick the section 4 immediately onto one of the leaflets 3 as shown schematically in FIG. 1, before the combination of individualized section 4 and leaflet 3 may be handed out to the customer. Thereby, the desired information, the individual printed section 4 is immediately connected with farther information on the leaflet. The recipient will thus not instantaneously throw away the leaflet 3 but will notice the information contained therein with high probability and take it into the office or the apartment.

Since the printed section 4 already emerges in adhesive condition from the cash point or the printer, it is merely necessary to separate the section from the rest of the roll 2, for example by pulling off and pressing it shortly against the leaflet 3. In this regard, the set 1 is located preferably in immediate vicinity of the cash point or the separate printer. This final step is facilitated since the leaflet comprises a bigger surface as an average single section 4. An accurate positioning of the leaflet is thus not absolutely necessary. Alternatively, it is also possible to provide equipment at the cash point, the printer or in addition thereto, which stick on the section 4 in a half or fully automated manner onto the leaflet 3.

The set 1 of leaflets 3 comprises a certain number of examples of the substantially identical leaflets 3. As a slight deviation from the total identity, for example, a numbering is conceivable. Also possible is the provision of multiple groups of substantially identical leaflets 3 in a common set 1. The number of leaflets 3 of the set is preferably adjusted to the length of the cash point roll 2, so that in normal consumption, for every section 4 substantially one leaflet 3 is provided. In the case of not predetermined section sizes, the average size of a section is taken as a basis.

The adhesive area 5 comprises a composition which ensures a stabile but manually releasable connection between a printed section 4 and a leaflet 3. It is also conceivable that, in addition, the surface of the leaflet 3 is chemically coated (not shown). Thereby, two objects may be achieved. On the one hand, the adhesive properties may be enhanced or actually occur for the first time when the adhesive area 5 comes into contact with the surface of the leaflet 3. In a further development, the manual releaseability of section and leaflet occurs with time delay (e.g. 10 minutes after the connection), whereby the customer is fully urged to take along the section 4 initially together with the leaflet.

Alternatively or in addition, the coating of the leaflet 3 may also provide that the adhesive effect between the leaflet 3 and the printed section 4 is temporary. This may be achieved through the selection of known chemicals by the person skilled in the art. As a result, the subsequent removal of the section 4 from the leaflet is facilitated. Yet, it is also conceivable to use a conventional adhesive, which initially ensures the stabile but releasable connection between the section 4 and the leaflet 3 and later serves for immediately sticking section 4 in a logbook. In each case, it is preferred when the printed section may later be removed from the leaflet substantially without residuals and is not damaged during the removal.

The leaflet—for example a single sheet of paper, cardboard or even a multi-page folded brochure—comprises preferably only a small format, in order that the combination of section 4 and leaflet 3 does not become too difficult to handle and will be faced with too great rejection from the side of the customer. Preferably, pocket formats ≦envelope format (22×11 cm) are used.

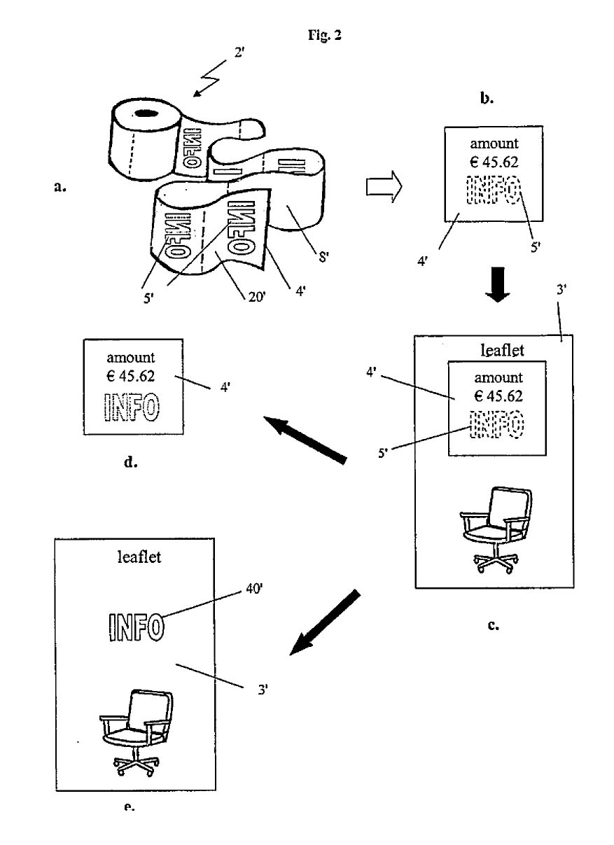

FIGS. 2-4 show a particularly preferred development of the illustrated system, which is explained in more detail in the following: In FIG. 2a, one can see a cash point roller 2′ with a front side 8′ and a backside 20′. The cash point roll 2′ may be printed in a known manner on the front side 8′ with desired information. Subsequently, the printed section is separated from the rest of the roll 2′ by cutting or pulling off. Although shown in the same size in the figures, sections 4′ may comprise different sizes. In general, the dimension of one section 4′ is depending on the amount of information printed on the front side 8′.

The backside 20′ of the cash point roll 2′ is provided with a bonding film 5′, in order to arrange the section 4′ onto an information carrier 3′, as explained above considering the example of a leaflet. The bonding film 5′ thereby has the shape of additional text information in the embodiment shown schematically in FIG. 2a. The bonding film 5′ can in this regard be colored in order to make the information to be communicated more easy to recognize or be nearly colorless and thus, similar to a water marking, only be noticeable under attentive observation.

In each case, the inventive configuration of the bonding film 5′ does not only enable a mounting of the section 4′ onto the information carrier 3′, but additional information can be communicated to the user, for example advertising messages, important information, telephone numbers or the like. The information in the form of the bonding film 5′ is in a simple embodiment identical for each section 4′, wherein the sections 4′ preferably comprise a minimum size, so that each section 4′ is provided with a bonding film 5′. However, it is likewise conceivable to apply individual symbols by the shape of the bonding film 5′ onto the backside 20′.

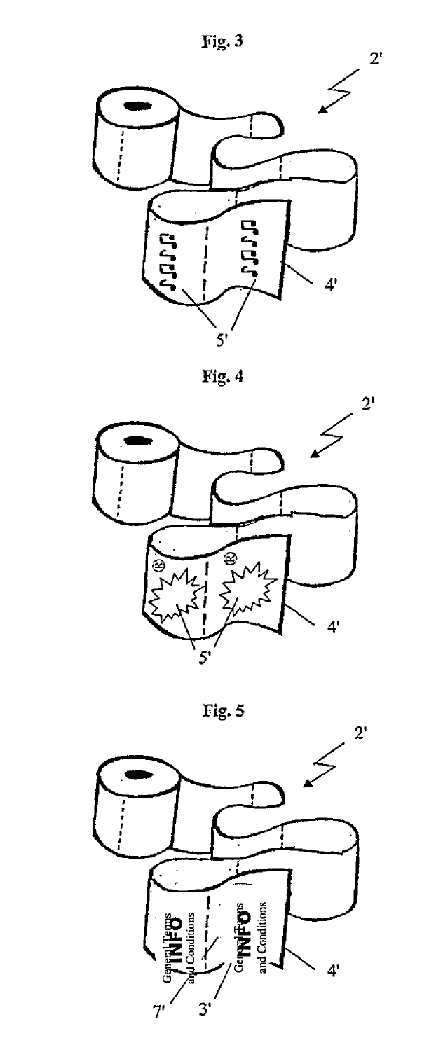

The bonding film 5′ can comprise the form of information communicating symbols. In the schematically illustrated embodiment in FIG. 3 according to the exemplary embodiment, the bonding film 5′ takes the shape of one or more music notes. FIG. 4 shows a further alternative, in which the shape of the bonding film 5′ refers by the reproduction of a trademark in word and/or picture format to a desired company or the like.

The information transmitting shape of bonding film 5′ will especially be noticed when the section 4′ is temporarily glued to the information carrier 3′, as shown in FIGS. 2c-e. If the bonding film 5′ is made of a suitable material, it may leave an imprint 40′ during the removal of the section 4′ from the information carrier 3′. The material compositions required therefor are well known to the person skilled in the field of bonding technique. For example, the bonding film 5′ may be colored to this end, so that the color is transmitted onto the information carrier 3′ as in the case of a dye.

Such an imprint 40′ could remain for a long time on the information carrier 3′ or be formed in such a way that it is easy to remove. This alternative is preferably used for advertising purposes. Here, a visible but in the long run not irremovable imprint 40′ of the bonding film 5′ will for a last time transport the desired advertising message, when the section 4′ is removed (cf. FIGS. 2d and e).

If the bonding film 5′ is formed in the described way, in order to leave a visible imprint 40′ subsequent to the removal of the section 4′, it is reasonable in the case of texts but also in the case of other information communicating symbols, to apply the respective bonding layer 5′ mirror-inverted onto the section 4′. FIGS. 2a-e point out the latter considering the mirror-inverted “INFO” on section 4′.

FIG. 5 finally shows a further embodiment, in which the backside 20′ not only comprises the inventive bonding film 5′ but is printed additionally in a known manner, e.g. with general terms and conditions 7′ or similar data of the user of the cash point roll. Also for such a cash point roll 2′, the bonding film 5′ may be applied in a form which, in addition to the front side S’ and the backside 20′ transmits further information to the user.

Although in this case, nearly transparent bonding films 5′ are preferably used (cf FIG. 5), it is also possible by using suitable chemicals to initially form a transparent bonding film in such a way that the latter will change color after removal from the role, e.g. through the contact with the ambient air, Thereby, initially the recognition of the printed data 7′ is enabled and subsequently, the special shape of the bonding film 5′ is clearly visible, so that the information contained therein will also be noticed.

1. Modular information system, in particular an advertising system, comprising:
a. a print medium having printable sections;
b. a set of separate, substantially identical information carriers, wherein each information carrier comprises a larger surface as an average section of the print medium;
c. a bonding element being arranged at at least each section, wherein the bonding element is suitable to connect a printed section and a separate information carrier to one another in a manually releasable manner, characterized in that
d. the print medium is formed as a cash point roll.

2. Modular information system according to claim 1, wherein the bonding element is formed as an adhesive film, which at least covers parts of the backside of section.

3. Modular information system according to claim 1, wherein the bonding element is formed as a bonding film, which comprises at least in a sub-section the form of an information communicating symbol.

4. Modular information system according to claim 3, wherein the bonding film comprises the form of one or more characters.

5. Modular information system according to claim 4, wherein the bonding film comprises periodically repeating symbols, which are arranged in such a way that at a minimum size of a section of the print medium at least one symbol is arranged on the backside of section.

6. Modular information system according to claim 5, wherein the bonding film comprises at least in a sub-section the form of an information communicating symbol in mirror-inverted orientation.

7. Modular information system according to claim 3, wherein the bonding film is formed of a visible but at the same time transparent material, so that additional information is visible on the backside of the print medium.

8. Modular information system according to claim 1, wherein the substantially identical information carriers respectively comprise one or more pages of paper.

9. Modular information system according to claim 1, wherein the information carrier comprises a format≦envelope format of 22 cm×11 cm.

10. Modular information system according to claim 1, wherein the number of information carriers in set substantially corresponds with the number of printable sections of the print medium.

11. Modular information system according to claim 1, wherein the bonding element is formed as a coating which may be activated by UV light, heat or something similar.

12. Modular information system according to claim 1, wherein the bonding element is formed as a magnetically and/or electrostatically loaded area of the printable sections.
